(19) United States
(12) Patent Application Publication
(10) Pub. No.: US 2004/0263467 A1
(43) Pub. Date: Dec. 30, 2004

(54) Display and method of controlling the same

(76) Inventors: Makoto Kitagawa, Anpachi-gun (JP); Ryoichi Yokoyama, Ogaki-shi (JP)

Correspondence Address: MCDERMOTT, WILL & EMERY, 600 13th Street, N.W., Washington, DC, 20005-3096, US

(21) Appl. No.: 10/812,399

(22) Filed: Mar. 30, 2004

(30) Foreign Application Priority Data
Jun. 25, 2003 (JP) JP2003-180599

(51) Int. Cl. G02F 1/1333

(52) U.S. Cl. 345/102

(57) ABSTRACT

A display capable of inhibiting brightness-gradation characteristics from dispersion in ON- and OFF-states of a light source is provided. This display comprises an applied voltage control part controlling a voltage applied to a display pixel. The applied voltage control part includes a control circuit outputting either at least either white reference voltage data or black reference voltage data corresponding to the ON-state of the light source or at least either white reference voltage data or black reference voltage data corresponding to the OFF-state of the light source.

### BACKGROUND OF THE INVENTION

1. Field of the Invention

The present invention relates to a display and a method of controlling the same, and more particularly, it relates to a display having a light source and a method of controlling the same.

2. Description of the Background Art

In relation to displays, liquid crystal displays displaying images on liquid crystal display panels are known in general. The aforementioned liquid crystal displays include a transmission liquid crystal display only unidirectionally passing light incident upon liquid crystals, a reflection liquid crystal display reflecting light incident upon liquid crystals and a semi-transmission liquid crystal display having both functions of the transmission and reflection displays. The semi-transmission liquid crystal display displays images by turning on/off a light source. More specifically, the semi-transmission liquid crystal display turns on a back light serving as the light source thereby introducing light emitted from the back light into liquid crystals in transmission display, while turning off the back light for introducing natural light into the liquid crystals in reflection display. A reflection liquid crystal display having a light source such as a front light for displaying images by turning on/off the light source in response to external brightness or the like is also known. This type of reflection liquid crystal display turns on the light source for reflectingly displaying images with only the light source or with the light source and natural light when it is dark outside, while turning off the light source for displaying images with natural light when it is bright outside.

A conventional semi-transmission liquid crystal display can control the brightness of images displayed on a liquid crystal display panel by controlling a voltage applied to liquid crystals. More specifically, light transmittance with respect to liquid crystals varies with the voltage applied to the liquid crystals in a normally white case as in a V-T (applied voltage-transmittance) characteristic diagram shown in FIG. 7, and hence the light transmittance is reduced if the applied voltage is increased and vice versa. Therefore, the brightness of the images displayed on the liquid crystal display panel can be reduced by setting the applied voltage high while the former can be increased by setting the latter low. Thus, it is possible to control the brightness of the images displayed on the liquid crystal display panel by setting the voltage applied to the liquid crystals to a prescribed value.

In general, it is known that the relation between brightness and input data (video data) is nonlinear (curve 100a in FIG. 8), as shown in FIG. 8. Therefore, a conventional liquid crystal display linearizes the relation between brightness and input data (video data) as shown by a straight line 100b in FIG. 8 by performing gamma correction. For example, Japanese Patent Laying-Open No. 2001-222264 discloses this technique. The term “gamma correction” denotes an operation of correcting input video data on the basis of gamma correction data previously set to a prescribed value or the like thereby linearizing the relation between brightness and the input data (video data). Images displayed on the liquid crystal display panel can be set to brightness corresponding to the input data (video data) due to this gamma correction.

When a conventional gamma correction method is applied to the semi-transmission liquid crystal display having the V-T characteristics shown in FIG. 7, however, it is disadvantageously difficult to set images displayed on the liquid crystal display panel to equivalent brightness-gradation characteristics in transmission display (back light: on) and reflection display (back light: off). More specifically, the V-T characteristics in the transmission display (back light: on) and in the reflection display (back light: of) are different from each other, as shown in FIG. 7. Therefore, when gamma correction data optimum for transmission display is employed, for example, the relation between brightness and input data (video data) in transmission display is linearly corrected while the relation between brightness and input data (video data) in reflection display is not linearly corrected. Thus, images displayed on the liquid crystal display in reflection display cannot attain brightness corresponding to input video data. Therefore, the brightness-gradation characteristics of images displayed on the liquid crystal display panel disadvantageously vary with transmission display (back light: on) and reflection display (back light: off). Consequently, the brightness-gradation characteristics of images displayed on the liquid crystal display panel are disadvantageously dispersed in transmission display (back light: on) and reflection display (back light: on).

Also in the reflection liquid crystal display having a light source such as a front light, brightness-gradation characteristics of images displayed on the liquid crystal display panel are disadvantageously dispersed in reflection display (light source: on) with light from the light source and reflection display (light source: off) with natural light.

### SUMMARY OF THE INVENTION

The present invention has been proposed in order to provide a display capable of inhibiting brightness-gradation characteristics from dispersion in ON- and OFF-states of a light source.

The present invention has also been proposed in order to provide a method of controlling a display capable of inhibiting brightness-gradation characteristics from dispersion in ON- and OFF-states of a light source.

In order to solve the aforementioned problems, a display according to a first aspect of the present invention comprises a light source and an applied voltage control part controlling a voltage applied to a display pixel in response to an ON- or OFF-state of the light source, while the applied voltage control part includes a control circuit detecting the ON- or OFF-state of the light source and outputting either at least either white reference voltage data or black reference voltage data corresponding to the ON-state of the light source or at least either white reference voltage data or black reference voltage data corresponding to the OFF-state of the light source on the basis of the ON- or OFF-state of the light source.

The display according to the first aspect can easily output at least either the white reference voltages or the black reference voltages corresponding to the ON- and OFF-states of the light source respectively. When generating voltages applied to the display pixel with at least either the white reference voltages or the black reference voltages, therefore, the display can apply optimum voltages to the display pixel in response to the ON- and OFF-states of the light source respectively so that equivalent brightness-gradation characteristics can be attained when the light source is in the ON- and OFF-states respectively. Consequently, the brightness-gradation characteristics can be inhibited from dispersion in the ON- and OFF-states of the light source.

A display according to a second aspect of the present invention comprises a light source and an applied voltage control part controlling a voltage applied to a display pixel in response to an ON- or OFF-state of the light source, while the applied voltage control part includes a memory storing at least either white reference voltage data or black reference voltage data corresponding to the ON-state of the light source and at least either white reference voltage data or black reference voltage data corresponding to the OFF-state of the light source and a selection circuit detecting the ON- or OFF-state of the light source and selecting either at least either the white reference voltage data or the black reference voltage data corresponding to the ON-state of the light source or at least either the white reference voltage data or the black reference voltage data corresponding to the OFF-state of the light source on the basis of the ON- or OFF-state of the light source.

The display according to the second aspect of the present invention, capable of selecting either at least either the white reference voltage data or the black reference voltage data corresponding to the ON-state of the light source or at least either the white reference voltage data or the black reference voltage data corresponding to the OFF-state of the light source previously stored in the memory with the selection circuit, can easily output the white reference voltages and the black reference voltages corresponding to the ON- and OFF-states of the light source respectively. When generating voltages applied to the display pixel with at least either the white reference voltages or the black references voltage, therefore, the display can apply optimum voltages to the display pixel in response to the ON- and OFF-states of the light source respectively so that equivalent brightness-gradation characteristics can be attained when the light source is in the ON- and OFF-states respectively. Consequently, the brightness-gradation characteristics can be inhibited from dispersion in the ON- and OFF-states of the light source.

A display according to a third aspect of the present invention comprises a light source and an applied voltage control part controlling a voltage applied to a display pixel in response to an ON- or OFF-state of the light source, while the applied voltage control circuit includes a gamma correction circuit detecting the ON- or OFF-state of the light source and gamma-correcting video data on the basis of either gamma correction data corresponding to the ON-state of the light source or gamma correction data corresponding to the OFF-state of the light source.

The display according to the third aspect can easily gamma-correct the video data input in the gamma correction circuit to video data corresponding to the ON- or OFF-state of the light source with the gamma correction data corresponding to the ON- or OFF state of the light source. When generating voltages applied to the display pixel with the gamma-corrected video data, therefore, the display can apply optimum voltages to the display pixel in response to the ON- and OFF-states of the light source respectively so that equivalent brightness-gradation characteristics can be attained when the light source is in the ON- and OFF-states respectively. Consequently, the brightness-gradation characteristics can be inhibited from dispersion in the ON- and OFF-states of the light source.

A method of controlling a display according to a fourth aspect of the present invention comprises steps of detecting an ON- or OFF-state of a light source having different bright-gradation characteristics and controlling a voltage applied to a display pixel in response to the ON- or OFF-state of the light source.

In the method of controlling a display according to the fourth aspect, optimum voltages can be applied to the display pixel in response to the ON- and OFF-states of the light source respectively so that equivalent brightness-gradation characteristics can be attained when the light source is in the ON- and OFF-states respectively. Consequently, the brightness-gradation characteristics can be inhibited from dispersion in the ON- and OFF-states of the light source.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the overall structure of a semi-transmission liquid crystal display according to a first embodiment of the present invention;

FIG. 2 is a block diagram showing the internal structure of a control circuit of the display according to the first embodiment shown in FIG. 1;

FIG. 3 is a V-T (applied voltage-transmittance) characteristic diagram of the display according to the first embodiment of the present invention;

FIG. 4 is a block diagram showing the overall structure of a semi-transmission liquid crystal display according to a second embodiment of the present invention;

FIG. 5 is a block diagram showing the internal structure of a gamma correction circuit of the display according to the second embodiment shown in FIG. 4;

FIG. 6 is a V-T (applied voltage-transmittance) characteristic diagram of the display according to the second embodiment of the present invention;

FIG. 7 is a V-T (applied voltage-transmittance) characteristic diagram for illustrating the relation between an applied voltage and transmittance in a conventional liquid crystal display; and

FIG. 8 is a correlation diagram for illustrating the relation between brightness and input data (video data) in the conventional liquid crystal display.

### DESCRIPTION OF THE PREFERRED EMBODIMENTS

Embodiments of the present invention are now described with reference to the drawings.

### First Embodiment

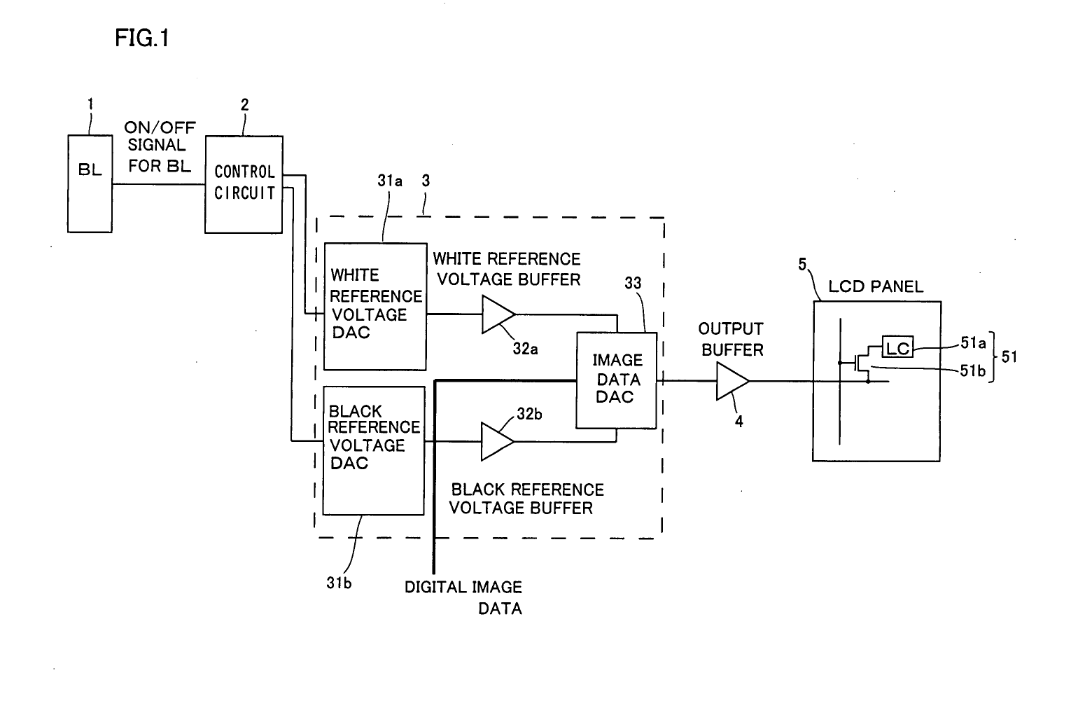

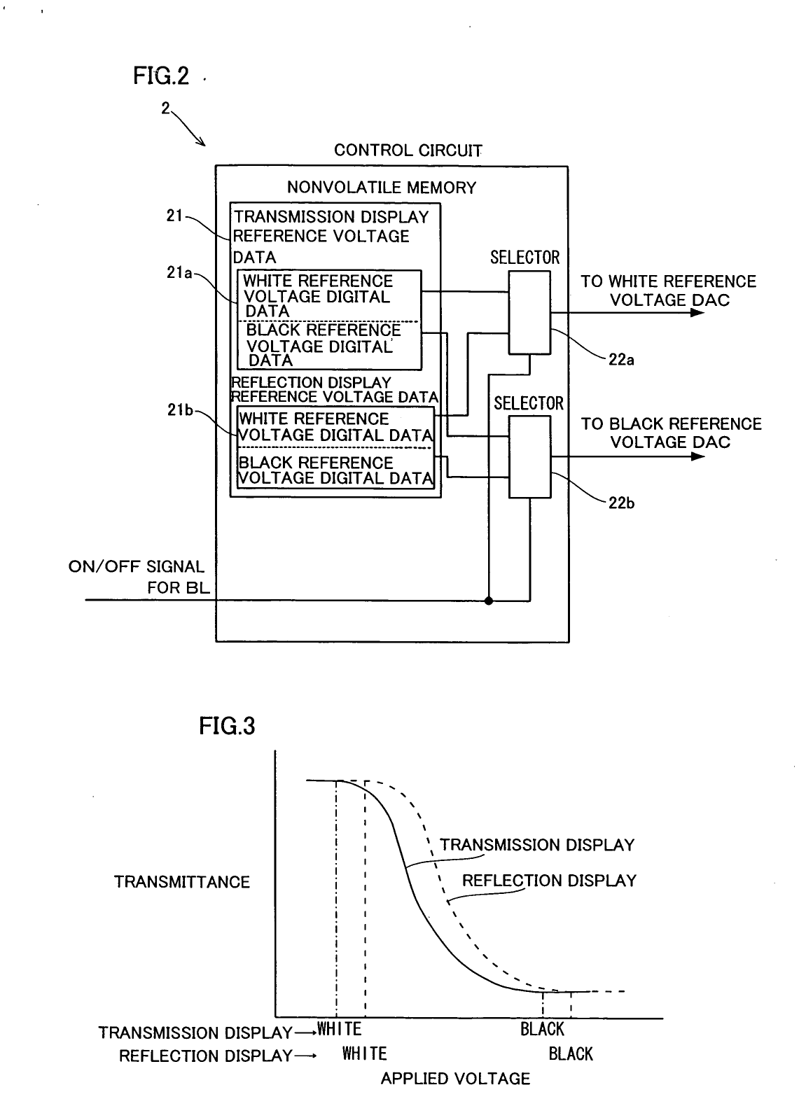

The structure of a semi-transmission liquid crystal display according to a first embodiment of the present invention is described with reference to FIGS. 1 and 2.

As shown in FIG. 1, the semi-transmission liquid crystal display according to the first embodiment comprises a back light (BL) 1, a control circuit 2, a DAC (digital-to-analog conversion circuit) part 3, an output buffer (buffer amplifier) 4 and a pixel region 5. The back light 1 is an example of the “light source” in the present invention, and the control circuit 2 is an example of the “applied voltage control part” in the present invention. The semi-transmission liquid crystal display according to the first embodiment turns on the back light 1 for transmission display, while turning off the back light 1 for reflection display.

According to the first embodiment, the control circuit 2 has a function of detecting an ON or OFF signal for the back light 1. The control circuit 2 also has a function of outputting either white reference voltage digital data and black reference voltage digital data corresponding to the ON signal for the back light 1 or white reference voltage digital data and black reference voltage data corresponding to the OFF signal for the back light 1 on the basis of the ON or OFF signal for the back light 1. More specifically, the control circuit 21 includes a nonvolatile memory 21 and selectors 22a and 22b. The nonvolatile memory 21 is an example of the “memory” in the present invention, and the selectors 22a and 22b are examples of the “selection circuit” in the present invention.

The nonvolatile memory 21 stores transmission display reference voltage data 21a including the white reference voltage digital data and the black reference voltage digital data corresponding to the ON signal for the back light 1 (see FIG. 1) and reflection display reference voltage data 21b including the white reference voltage digital data and the black reference voltage digital data corresponding to the OFF signal for the back light 1. The transmission display reference voltage data 21a and the reflection display reference voltage data 21b are so set that brightness-gradation characteristics are substantially identical to each other in transmission display and reflection display respectively. The selectors 22a and 22b have functions of detecting the ON or OFF signal for the back light 1 and selecting and outputting either the transmission display reference voltage data 21a or the reflection display reference voltage data 21b on the basis of the ON or OFF signal. In other words, the selectors 22a and 22b select the transmission display reference voltage data 21a when detecting the ON signal for the back light 1, while selecting the reflection display reference voltage data 21b when detecting the OFF signal for the back light 1.

As shown in FIG. 1, the DAC part 3 includes a white reference voltage DAC 31a and a white reference voltage buffer (buffer amplifier) 32a, a black reference voltage DAC 31b and a black reference voltage buffer (buffer amplifier) 32b and a video data DAC 33. The white reference voltage DAC 31a has a function of converting the white reference voltage digital data of either the transmission display reference voltage data 21a (see FIG. 2) or the reflection display reference voltage data 21b (see FIG. 2) output from the control circuit 2 from a digital signal to an analog signal (DC voltage). The black reference voltage DAC 31b has a function of converting the black reference voltage digital data of either the transmission display reference voltage data 21a or the reflection display reference voltage data 21b output from the control circuit 2 from a digital signal to an analog signal (DC voltage). The white reference voltage buffer 32a and the black reference voltage buffer 32b have functions of isolating the white reference voltage DAC 31a and the black reference voltage DAC 31b from influence by a load of the video data DAC 33 while improving drivability for signals from the white reference voltage DAC 31a and the black reference voltage DAC 31b and supplying reference voltages to the video data DAC 33.

The video data DAC 33 has a function of converting external digital video data from a digital signal to an analog signal on the basis of either the transmission display reference voltage data 21a or the reflection display reference voltage data 21b converted to the analog signal. Brightness-gradation characteristics of images displayed on the pixel region 5 are generally controlled with analog signals. Therefore, the liquid crystal display according to the first embodiment receiving the digital video data requires the video data DAC 33.

The output buffer 4 has a function of isolating the video data DAC 33 from influence by a load of the pixel region 5 while improving drivability of the analog video data output from the video data DAC 33 and supplying the data to the pixel region 5. This output buffer 4 improves the drivability of the analog video data converted by the video data DAC to 33 a level sufficient for charging/discharging the pixel region 5. In the pixel region 5, display pixels 51 each including a liquid crystal 51a and a transistor 51b are arranged in the form of a matrix. The analog video data supplied to the liquid crystal display panel 5 is applied to the liquid crystal 51a through the transistor 51b.

Operations of the semi-transmission liquid crystal display according to the first embodiment are now described with reference to FIGS. 1 to 3. First, the liquid crystal display turns on the back light 1 for transmission display, while turning off the back light 1 for reflection display. Further, the liquid crystal display inputs the digital video data in the video data DAC 33 constituting the DAC part 3.

At this time, the selectors 22 and 22b constituting the control circuit 2 shown in FIG. 2 detect the ON or OFF signal for the back light 1 according to the first embodiment. When detecting the ON signal, the selectors 22a and 22b select the transmission display reference voltage data (the white reference voltage digital data and the black reference voltage digital data) 21a. When detecting the OFF signal, on the other hand, the selectors 22a and 22b select the reflection display reference voltage data (the white reference voltage digital data and the black reference voltage digital data) 21b. Thereafter the control circuit 2 outputs the selected transmission or reflection display reference voltage data 21a or 21b.

The white reference voltage DAC 31a and the black reference voltage DAC 31b shown in FIG. 1 convert the white reference voltage digital data and the black reference voltage digital data of the transmission display reference voltage data 21a or the reflection display reference voltage data 21b from digital signals to analog signals. Thereafter the white reference voltage digital data and the black reference voltage digital data of the transmission display reference voltage data 21a or the reflection display reference voltage data 21b are input in the video data DAC 33 through the white reference voltage buffer 32a and the black reference voltage buffer 32b respectively. In other words, a white reference voltage and a black reference voltage for transmission display shown in FIG. 3 are input in the video data DAC 33 for transmission display (back light 1: on). For reflection display (back light 1: off), on the other hand, a white reference voltage and a black reference voltage for transmission display shown in FIG. 3 are input in the video data DAC 33.

Thus, the video data DAC 33 converts the digital video data received therein from a digital signal to an analog signal on the basis of the white reference voltage and the black reference voltage for transmission display shown in FIG. 3 in transmission display (back light 1: on) in the liquid crystal display according to the first embodiment. In reflection display (back light 1: off), on the other hand, the video data DAC 33 converts the digital video data received therein from a digital signal to an analog signal on the basis of the white reference voltage and the black reference voltage for reflection display shown in FIG. 3.

The converted analog video data is applied through the output buffer 4 to the liquid crystal 51a constituting each display pixel 51 of the pixel region 5 through the transistor 51b, as shown in FIG. 1.

V-T characteristics in transmission display (back light 1: on) and in reflection display (back light 1: off) are different from each other, as shown in FIG. 3. In consideration of this point, the liquid crystal display according to the first embodiment sets the white and black reference voltages for transmission display and those for reflection display so that the brightness-gradation characteristics are substantially identical to each other in transmission display and reflection display. In other words, the liquid crystal display according to the first embodiment previously sets the white and black reference voltages for transmission display shown in FIG. 3 smaller than the white and black reference voltages for reflection display shown in FIG. 3 so that the brightness-gradation characteristics are substantially identical to each other in transmission display and reflection display. When the digital video data input in transmission display (back light 1: on) and in reflection display (back light 1: off) are identical to each other, therefore, the voltage applied to the liquid crystal 51a for transmission display is lower than that applied to the liquid crystal 51a for reflection display. Consequently, the brightness-gradation characteristics are substantially equalized with each other in transmission display (back light 1: on) and in reflection display (back light 1: off).

The liquid crystal display according to the first embodiment, provided with the control circuit 2 detecting the ON or OFF signal for the back light 1 and outputting either the white and black reference voltage digital data corresponding to the ON signal for the back light 1 or the white and black reference voltage digital data corresponding to the OFF signal for the back light 1 as hereinabove described, can easily output white and black reference voltages responsive to transmission display (back light 1: on) and reflection display (back light 1: off) respectively. When generating the voltage applied to the liquid crystal 51a constituting each display pixel 51 with the white and black reference voltages, therefore, the liquid crystal display can easily apply the optimum voltage to the liquid crystal 51a in response to transmission display or reflection display so that equivalent brightness-gradation characteristics can be attained in transmission display (back light 1: on) and in reflection display (back light 1: off). Consequently, the brightness-gradation characteristics can be inhibited from dispersion in transmission display (back light 1: on) and in reflection display (back light 1: off).

Further, the liquid crystal display according to the first embodiment, having the control circuit 2 provided with the nonvolatile memory 21 storing the transmission display reference voltage data 21a and the reflection display reference voltage data 21b corresponding to the ON and OFF signals for the back light 1 respectively and the selectors 22a and 22b detecting the ON or OFF signal for the back light 1 for selecting and outputting either the transmission display reference voltage data 21a or the reflection display reference voltage data 21b on the basis of the ON or OFF signal, can select either the transmission display reference voltage data 21a or the reflection display reference voltage data 21b previously stored in the nonvolatile memory 21 with the selectors 22a and 22b. Thus, the liquid crystal display according to the first embodiment can easily select and output the transmission display reference voltage data 21a or the reflection display reference voltage data 21b corresponding to the ON or OFF signal for the back light 1.

In addition, the liquid crystal display according to the first embodiment provided with the DAC part 3 can easily convert the digital video data to analog video data corresponding to transmission display (back light 1: on) or reflection display (back light 1: off) on the basis of the transmission display reference voltage data 21a or the reflection display reference voltage data 21b corresponding to the ON or OFF signal for the back light 1.

### SECOND EMBODIMENT

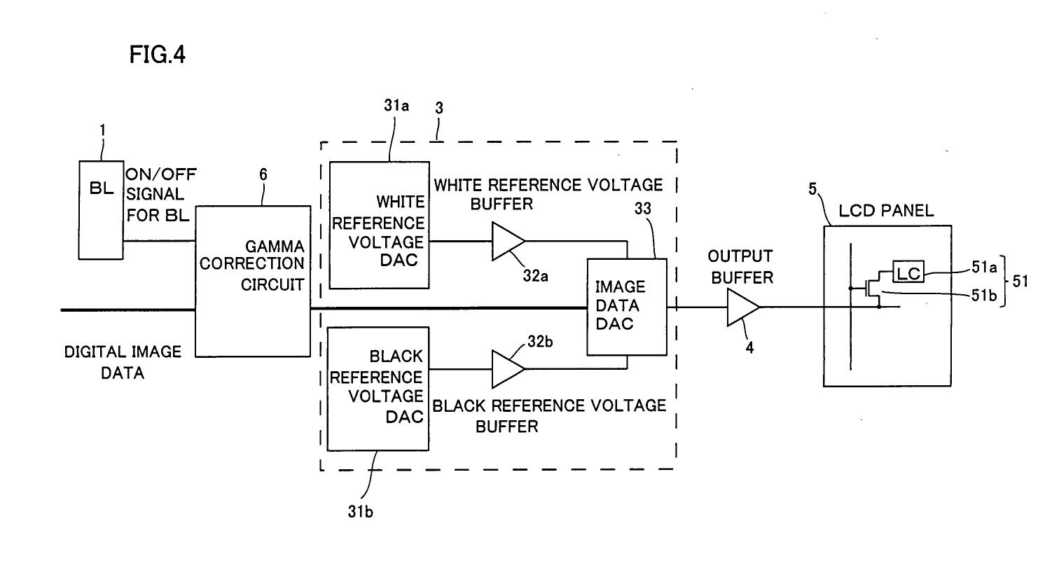

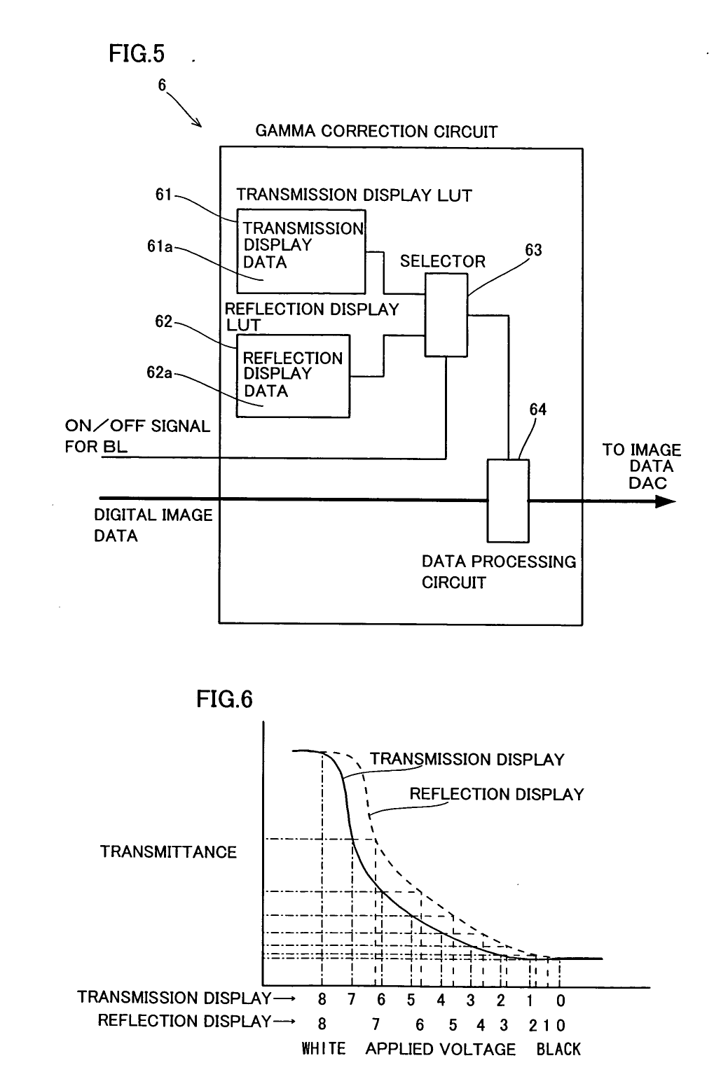

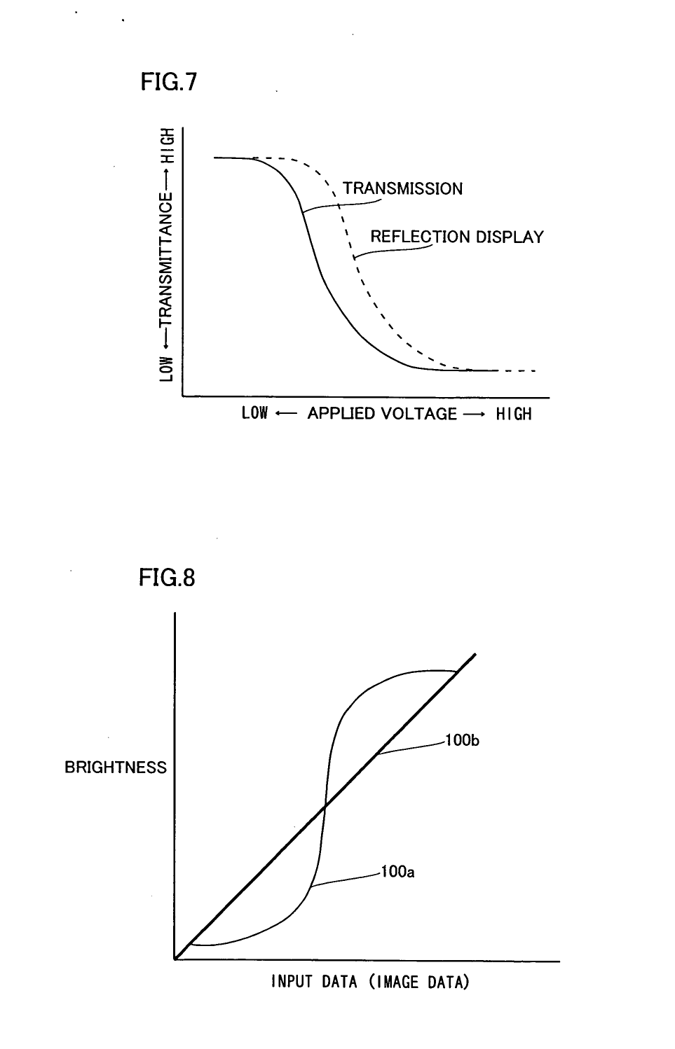

Referring to FIGS. 4 and 5, a semi-transmission liquid crystal display according to a second embodiment of the present invention applies a voltage subjected to gamma correction responsive to an ON or OFF signal for a back light 1 to a liquid crystal 51a, dissimilarly to the aforementioned first embodiment.

As shown in FIG. 4, the liquid crystal display according to the second embodiment comprises the back light 1, a DAC part 3, an output buffer 4, a pixel region 5 and a gamma correction circuit 6. The gamma correction circuit 6 is an example of the “applied voltage control part” in the present invention. The liquid crystal display according to the second embodiment turns on the back light 1 for transmission display while turning off the back light 1 for reflection display, similarly to the aforementioned first embodiment.

According to the second embodiment, the gamma correction circuit 6 has a function of detecting the ON or OFF signal for the back light 1. The gamma correction circuit 6 also has a function of gamma-correcting external digital video data on the basis of either gamma correction digital data corresponding to the ON signal for the back light 1 or gamma correction digital data corresponding to the OFF signal for the back light 1. More specifically, the gamma correction circuit 6 includes a transmission display LUT (lookup table) 61 storing transmission display data 61a and a reflection display LUT 62 storing reflection display data 62a, a selector 63 and a data processing circuit 64. The transmission display LUT 61 and the reflection display LUT 62 are examples of the “storage part” in the present invention, and the selector 63 is an example of the “selection circuit” in the present invention.

The transmission display data 61a stored in the transmission display LUT 61 is gamma correction digital data corresponding to the ON signal for the back light 1 (see FIG. 4), and the reflection display data 62a stored in the reflection display LUT 62 is gamma correction digital data corresponding to the OFF signal for the back light 1. The transmission display data 61a and the reflection display data 62a are so set that brightness-gradation characteristics are substantially identical to each other in transmission display and in reflection display made with video data supplied to the pixel region 5 after gamma correction. The selector 63 has a function of detecting the ON or OFF signal for the back light 1 and selecting and outputting either the transmission display data 61a or the reflection display data 62a on the basis of the ON or OFF signal. In other words, the selector 63 selects the transmission display data 61a when detecting the ON signal for the back light 1, while selecting the reflection display data 62a when detecting the OFF signal for the back light 1. The data processing circuit 64 has a function of receiving external digital video data and gamma-correcting the external digital video data on the basis of either the transmission display data 61a or the reflection display data 62a.

As shown in FIG. 4, the DAC part 3 includes a white reference voltage DAC 31a and a white reference voltage buffer 32a, a black reference voltage DAC 31b and a black reference voltage buffer 32b and a video data DAC 33, similarly to the aforementioned first embodiment. According to the second embodiment, however, no white and black reference voltage digital data corresponding to the ON and OFF signals for the back light 1 respectively are input in the white reference voltage DAC 31a and the black reference voltage DAC 31b. In other words, the white reference voltage DAC 31a and the black reference voltage DAC 31b regularly input constant white reference voltage analog data (DC voltage) and constant black reference voltage analog data (DC voltage) in the video data DAC 33 respectively regardless of transmission display (back light 1: on) or reflection display (back light 1: off), dissimilarly to the aforementioned first embodiment.

The analog video data converted by the video data DAC 33 is supplied to the liquid crystal display panel 5 through the output buffer 4, similarly to the aforementioned first embodiment. The analog video data supplied to the liquid display panel 5 is applied to the liquid crystal 51a through a transistor 51b.

Operations of the semi-transmission liquid crystal display according to the second embodiment are now described with reference to FIGS. 4 to 6. First, the liquid crystal display turns on the back light 1 for transmission display, while turning off the back light 1 for reflection display. Further, the liquid crystal display inputs the digital video data in the video data DAC 33 constituting the DAC part 3 through the gamma correction circuit 6.

At this time, the data processing circuit 64 constituting the gamma correction circuit 6 receives the digital video data while the selector 63 constituting the gamma correction circuit 6 detects the ON or OFF signal for the back light 1 in the second embodiment, as shown in FIG. 5. When detecting the ON signal, the selector 63 selects the transmission display data (gamma correction digital data) 61a. When detecting the OFF signal, on the other hand, the selector 63 selects the reflection display data (gamma correction digital data) 62a. Thereafter the selected transmission or reflection display data 61a or 62a is input in the data processing circuit 64.

In transmission display (back light 1: on), the gamma correction circuit 6 gamma-corrects the digital video data received in the data processing circuit 64 on the basis of the gamma correction digital data of the transmission display data 61a. In reflection display (back light 1: off), on the other hand, the gamma correction circuit 6 gamma-corrects the digital video data received in the data processing circuit 64 on the basis of the gamma correction digital data of the reflection display data 62a. In other words, the gamma correction circuit 6 gamma-corrects the received digital video data to transmission display digital video data (“0” to “8”) shown in FIG. 6 for transmission display (back light 1: on). For reflection display (back light 1: off), on the other hand, the gamma correction circuit 6 gamma-corrects the digital video data to reflection display digital video data (“0” to “8”) shown in FIG. 6.

As shown in FIG. 4, the white reference voltage analog data (DC voltage) and the black reference voltage analog data (DC voltage) output from the white reference voltage DAC 31a and the black reference voltage DAC 31b respectively are input in the video data DAC 33 through the white reference voltage buffer 32a and the black reference voltage buffer 32b respectively. Thus, the video data DAC 33 converts the digital video data received therein from digital signals to analog signals on the basis of the white and black reference voltages received therein. In other words, the video data DAC 33 converts the transmission display digital video data (“0” to “8”) shown in FIG. 6 from the digital signals to corresponding analog signals in transmission display (back light 1: on) according to the second embodiment. In reflection display (back light 1: off), on the other hand, the video data DAC 33 converts the reflection display digital video data (“0” to “8”) shown in FIG. 6 from the digital signals to corresponding analog signals.

The converted analog video data is applied through the output buffer 4 to the liquid crystal 51a constituting each display pixel 51 of the pixel region 5, as shown in FIG. 4.

V-T characteristics in transmission display (back light 1: on) and in reflection display (back light 1: off) are different from each other, as shown in FIG. 6. According to the second embodiment, the liquid crystal display performs gamma correction so that brightness-gradation characteristics are substantially identical to each other in transmission display and in reflection display. More specifically, the liquid crystal display according to the second embodiment gamma-corrects the digital video data (“0” to “8”) so that the brightness-gradation characteristics corresponding to the voltages after conversion of the transmission and reflection display digital video data (“0” to “8”) respectively are substantially identical to each other. Consequently, the brightness-gradation characteristics are substantially equalized with each other in transmission display (back light 1: on) and in reflection display (back light 1: off).

The liquid crystal display according to the second embodiment, provided with the gamma correction circuit 6 detecting the ON or OFF signal for the back light 1 and gamma-correcting the external digital video data on the basis of either the gamma correction digital data corresponding to the ON signal for the back light 1 or that corresponding to the OFF signal for the back light 1, can easily gamma-correct the digital video data received in the gamma correction circuit 6 to digital video data corresponding to transmission display or reflection display with the gamma correction digital data corresponding to transmission display (back light 1: on) or reflection display (back light 1: off). When generating the voltage applied to the liquid crystal 51a constituting each display pixel 51 with the gamma-corrected digital video data, therefore, the liquid crystal display can easily apply the optimum voltage to the liquid crystal 51a in response to transmission display or reflection display so that equivalent brightness-gradation characteristics can be attained in transmission display (back light 1: on) and in reflection display (back light 1: off). Consequently, the brightness-gradation characteristics can be inhibited from dispersion in transmission display (back light 1: on) and in reflection display (back light 1: off), similarly to the aforementioned first embodiment.

Further, the liquid crystal display according to the second embodiment, having the gamma correction circuit 6 provided with the transmission display LUT 61 storing the transmission display data 61a corresponding to the ON signal for the back light 1, the reflection display LUT 62 storing the reflection display data 62a corresponding to the OFF signal for the back light 1 and the selector 63 detecting the ON or OFF signal for the back light 1 and selecting and outputting either the transmission display data 61a or the reflection display data 62a, can select either the transmission display data 61a previously stored in the transmission display LUT 61 or the reflection display data 62a previously stored in the reflection display LUT 62 with the selector 63. Thus, the liquid crystal display can easily select and gamma-correct either the transmission display data 61a corresponding to the ON signal for the back light 1 or the reflection display data 62a corresponding to the OFF signal for the back light 1.

In addition, the liquid crystal display according to the second embodiment provided with the DAC part 3 can easily convert the digital video data gamma-corrected on the basis of the gamma correction digital data of the transmission display data 61a corresponding to the ON signal for the back light 1 or the reflection display data 62a corresponding to the OFF signal for the back light 1 to analog video data corresponding to transmission display (back light 1: on) or reflection display (back light 1: off).

Although the present invention has been described and illustrated in detail, it is clearly understood that the same is by way of illustration and example only and is not to be taken by way of limitation, the spirit and scope of the present invention being limited only by the terms of the appended claims.

For example, the present invention is not restricted to the aforementioned first and second embodiments but is also applicable to a reflection liquid crystal display having a light source such as a front light for reflecting light from the light source or natural light by turning on or off the light source.

The present invention is not restricted to the aforementioned first and second embodiments but may alternatively employ an applied voltage control part other than the control circuit 2 or the gamma correction circuit 6.

The present invention is not restricted to the aforementioned first and second embodiments but may alternatively employ storage means other than the nonvolatile memory 21 or the LUTs 61 and 62.

The present invention is not restricted to the aforementioned first and second embodiments but may alternatively control analog video data in response to an ON- or OFF-state of a light source. Further alternatively, a switch may be connected between a DAC part and a pixel region for supplying analog video data from the DAC part to the pixel region by opening this switch with a shift register at arbitrary timing.

The present invention is not restricted to the aforementioned first and second embodiments but may alternatively correct video data on the basis of only either white reference voltage digital data or black reference digital data corresponding to an ON- or OFF-state of a back light.

The present invention is not restricted to the aforementioned first and second embodiments but is also applicable to a case of correcting externally received analog video data on the basis of white reference voltage analog data and black reference voltage analog data. In this case, the liquid crystal display may convert the externally received analog video data from a digital signal to an analog signal for thereafter correcting the analog video data on the basis of the white reference voltage analog data and the black reference voltage analog data.

What is claimed is:

1. A display comprising:
a light source; and
an applied voltage control part controlling a voltage applied to a display pixel in response to an ON- or OFF-state of said light source, wherein
said applied voltage control part includes a control circuit detecting said ON- or OFF-state of said light source and outputting either at least either white reference voltage data or black reference voltage data corresponding to said ON-state of said light source or at least either white reference voltage data or black reference voltage data corresponding to said OFF-state of said light source on the basis of said ON- or OFF-state of said light source.

2. The display according to claim 1, wherein said control circuit includes:
a memory storing at least either said white reference voltage data or said black reference voltage corresponding to said ON-state of said light source and at least either said white reference voltage data or said black reference voltage data corresponding to said OFF-state of said light source, and
a selection circuit detecting said ON- or OFF-state of said light source and selecting either at least either said white reference voltage data or said black reference voltage corresponding to said ON-state of said light source or at least either said white reference voltage data or said black reference voltage data corresponding to said OFF-state of said light source on the basis of said ON- or OFF-state of said light source.

3. The display according to claim 1, wherein
said white reference voltage data and said black reference voltage data are digital data,
said display further comprising a reference voltage digital-to-analog conversion circuit converting at least either said white reference voltage data or said black reference voltage corresponding to said ON-state of said light source and at least either said white reference voltage data or said black reference voltage data corresponding to said OFF-state of said light source from digital signals to analog signals.

4. The display according to claim 1, wherein
video data supplied to said display is digital data,
said display further comprising a video data digital-to-analog conversion circuit converting said video data from a digital signal to an analog signal on the basis of either at least either said white reference voltage data or said black reference voltage data corresponding to said ON-state of said light source or at least either said white reference voltage data or said black reference voltage data corresponding to said OFF-state of said light source.

5. The display according to claim 4, wherein
said video data digital-to-analog conversion circuit converts said video data from said digital signal to said analog signal on the basis of both of said white reference voltage data and said black reference voltage data.

6. The display according to claim 1, wherein
video data supplied to said display is digital data,
said display further comprising a video data digital-to-analog conversion circuit converting said video data from a digital signal to an analog signal before correcting said video data on the basis of either at least either said white reference voltage data or said black reference voltage corresponding to said ON-state of said light source or at least either said white reference voltage data or said black reference voltage data corresponding to said OFF-state of said light source.

7. The display according to claim 6, wherein
said video data digital-to-analog conversion circuit converts said video data from said digital signal to said analog signal on the basis of both of said white reference voltage data and said black reference voltage data.

8. The display according to claim 1, further comprising a transmission region and a reflection region,
for displaying with at least said transmission region when said light source is in said ON-state while displaying with said reflection region when said light source is in said OFF-state, and
applying a transmission voltage to said display pixel with said applied voltage control part when said light source is in said ON-state while applying a reflection voltage to said display pixel with said applied voltage control part when said light source is in said OFF-state.

9. The display according to claim 1, wherein
said applied voltage control part controls said voltage applied to said display pixel in response to said ON- or OFF-state of said light source so that brightness-gradation characteristics in said ON-state of said light source and brightness-gradation characteristics in said OFF-state of said light source are substantially identical to each other.

10. A display comprising:
a light source; and
an applied voltage control part controlling a voltage applied to a display pixel in response to an ON- or OFF-state of said light source, wherein
said applied voltage control part includes:
a memory storing at least either white reference voltage data or black reference voltage data corresponding to said ON-state of said light source and at least either white reference voltage data or black reference voltage data corresponding to said OFF-state of said light source, and
a selection circuit detecting said ON- or OFF-state of said light source and selecting at least either at least either said white reference voltage data or said black reference voltage data corresponding to said ON-state of said light source or at least either said white reference voltage data or said black reference voltage data corresponding to said OFF-state of said light source on the basis of said ON- or OFF-state of said light source.

11. The display according to claim 10, wherein
said white reference voltage data and said black reference voltage data are digital data,
said display further comprising a reference voltage digital-to-analog conversion circuit converting at least either said white reference voltage digital data or said black reference voltage digital data corresponding to said ON-state of said light source and at least either said white reference voltage digital data or said black reference voltage digital data corresponding to said OFF-state of said light source from digital signals to analog signals.

12. The display according to claim 10, wherein
video data supplied to said display is digital data,
said display further comprising a video data digital-to-analog conversion circuit converting said video data from a digital signal to an analog signal on the basis of either at least either said white reference voltage data or said black reference voltage corresponding to said ON-state of said light source or at least either said white reference voltage data or said black reference voltage data corresponding to said OFF-state of said light source.

13. The display according to claim 12, wherein
said video data digital-to-analog conversion circuit converts said video data from said digital signal to said analog signal on the basis of both of said white reference voltage data and said black reference voltage data.

14. The display according to claim 10, wherein
video data supplied to said display is digital data,
said display further comprising a video data digital-to-analog conversion circuit converting said video data from a digital signal to an analog signal before correcting said video data on the basis of either at least either said white reference voltage data or said black reference voltage corresponding to said ON-state of said light source or at least either said white reference voltage data or said black reference voltage data corresponding to said OFF-state of said light source.

15. The display according to claim 14, wherein
said video data digital-to-analog conversion circuit converts said video data from said digital signal to said analog signal on the basis of both of said white reference voltage data and said black reference voltage data.

16. The display according to claim 10, further comprising a transmission region and a reflection region,
for displaying with at least said transmission region when said light source is in said ON-state while displaying with said reflection region when said light source is in said OFF-state, and
applying a transmission voltage to said display pixel with said applied voltage control part when said light source is in said ON-state while applying a reflection voltage to said display pixel with said applied voltage control part when said light source is in said OFF-state.

17. The display according to claim 10, wherein said applied voltage control part controls said voltage applied to said display pixel in response to said ON- or OFF-state of said light source so that brightness-gradation characteristics in said ON-state of said light source and brightness-gradation characteristics in said OFF-state of said light source are substantially identical to each other.

18. A display comprising:
a light source; and
an applied voltage control part controlling a voltage applied to a display pixel in response to an ON- or OFF-state of said light source, wherein
said applied voltage control circuit includes a gamma correction circuit detecting said ON- or OFF-state of said light source and gamma-correcting video data on the basis of either gamma correction data corresponding to said ON-state of said light source or gamma correction data corresponding to said OFF-state of said light source.

19. The display according to claim 18, wherein
said gamma correction circuit includes:
a storage part storing said gamma correction data corresponding to said ON-state of said light source and said gamma correction data corresponding to said OFF-state of said light source,
a selection circuit detecting said ON- or OFF-state of said light source and selecting either said gamma correction data corresponding to said ON-state of said light source or said gamma correction data corresponding to said OFF-state of said light source on the basis of said ON- or OFF-state of said light source, and
a data processing circuit gamma-correcting said video data on the basis of either said gamma correction data corresponding to said ON-state of said light source or said gamma correction data corresponding to said OFF-state of said light source.

20. The display according to claim 18, wherein
said gamma correction data are digital data,
said display further comprising a digital-to-analog conversion circuit converting said video data gamma-corrected with said gamma correction digital data from a digital signal to an analog signal.

21. The display according to claim 18, further comprising a transmission region and a reflection region, for displaying with at least said transmission region when said light source is in said ON-state while displaying with said reflection region when said light source is in said OFF-state, and
applying a transmission voltage to said display pixel with said applied voltage control part when said light source is in said ON-state while applying a reflection voltage to said display pixel with said applied voltage control part when said light source is in said OFF-state.

22. The display according to claim 18, wherein
said applied voltage control part controls said voltage applied to said display pixel in response to said ON- or OFF-state of said light source so that brightness-gradation characteristics in said ON-state of said light source and brightness-gradation characteristics in said OFF-state of said light source are substantially identical to each other.

23. A method of controlling a display, comprising steps of:
detecting an ON- or OFF-state of a light source having different bright-gradation characteristics; and
controlling a voltage applied to a display pixel in response to said ON- or OFF-state of said light source.

24. The method of controlling a display according to claim 23, wherein
said step of controlling said voltage applied to said display pixel includes a step of controlling said voltage applied to said display pixel in response to said ON- or OFF-state of said light source so that brightness-gradation characteristics in said ON-state of said light source and brightness-gradation characteristics in said OFF-state of said light source are substantially identical to each other.
